(19) United States
(12) Patent Application Publication
(10) Pub. No.: US 2015/0053179 A1
(43) Pub. Date: Feb. 26, 2015

(54) METHOD FOR CONTROLLING AN INTERNAL COMBUSTION ENGINE

(71) Applicants: Brahim Baqasse, Stuttgart (DE); Michael Walter, Kornwestheim (DE); Bjoern Bischoff, Ludwigsburg (DE); Stefan Bollinger, Marbach Am Neckar (DE); Udo Schulz, Vaihingen/Enz (DE); Markus Hernier, Gerlingen (DE); Thiebaut Beyrath, Stuttgart (DE)

(72) Inventors: Brahim Baqasse, Stuttgart (DE); Michael Walter, Kornwestheim (DE); Bjoern Bischoff, Ludwigsburg (DE); Stefan Bollinger, Marbach Am Neckar (DE); Udo Schulz, Vaihingen/Enz (DE); Markus Hernier, Gerlingen (DE); Thiebaut Beyrath, Stuttgart (DE)

(21) Appl. No.: 14/376,351

(22) PCT Filed: Jan. 14, 2013
(86) PCT No.: PCT/EP2013/050568

§ 371 Date: Aug. 1, 2014

(30) Foreign Application Priority Data
Feb. 3, 2012 (DE) 10 2012 201 601.5

(51) Int. Cl. F02D 41/40; F02D 35/02

(52) U.S. Cl. CPC F02D 41/40; F02D 35/023
USPC 123/435

(57) ABSTRACT

A method for controlling an internal combustion engine includes: using the pressure sensor method, determining for a first injector a first control period during which a desired quantity of fuel is injected into a lead cylinder; controlling the first injector with the first control period and entering a quantity replacement signal resulting therefrom into a training characteristic field as a function of the drive train parameters; and using null quantity calibration, varying for all further cylinders a control period of the injectors assigned to the cylinders until the quantity replacement signal is reached.

### BACKGROUND OF THE INVENTION

1. Field of the Invention

The present invention relates to a method for controlling an internal combustion engine.

2. Description of the Related Art

In modern fuel injection systems of the type under consideration here, for example in common-rail diesel injection systems, in order to improve the mixture preparation partial injections having relatively small fuel quantities are made temporally before or after the actual main injections. The overall injected quantity, standardly calculated on the basis of a torque demanded by the driver, is for example divided between two pre-injections and one main injection. The injected quantities of the pre-injections should here be as small as possible in order to avoid disadvantageous emissions. On the other hand, the pre-injected quantities must be large enough that the minimum quantity of fuel required for the combustion process is always injected, taking into account all tolerance sources. A significant source of these tolerances is a drift of the injectors due to aging.

From published German patent application document DE 199 45 618 A1, a method is known by which the drift of an injector is adapted and compensated via a so-called null quantity calibration. Here, in an overrun operating period of the internal combustion engine a control period, and thus the injected fuel quantity of each individual injector, is varied until a change occurs in a so-called quantity replacement signal. Because the injected quantity of fuel cannot be measured directly, a quantity replacement signal is used that is correlated with the injected quantity of fuel.

The quantity replacement signal is for example a change in the rotational speed of the crankshaft, an output signal of a lambda sensor, or an output signal of an ionic current sensor. The control period of the injector during which a change of the quantity replacement signal occurs is stored as a minimum control period and is used to compensate the drift of the injector.

Published German patent application document DE 10 2008 002 482 A1 describes a method that evaluates a relation between the values for the minimum control period and the respective injected quantity that result in the above-explained null quantity calibration, using regression calculation, in order to improve the training of a null quantity calibration value.

A method for regulation and adaptation of pre-injected quantities is known from published German patent application document DE 10 2004 001 119 A1 (pressure sensor method). Here, using a pressure sensor that is situated on a cylinder, from the pressure curve during combustion, the so-called heat curve, the partial quantities of the injection are determined and are regulated to target values.

In addition, from published German patent application document DE 10 2006 026 640 A1, a method is known in which, during operating states of an internal combustion engine in which differences and/or fluctuations of the rotational speed are essentially a function of a combustion position, the time of the fuel injection is adapted for the reduction of the differences and/or fluctuations.

### BRIEF SUMMARY OF THE INVENTION

A basic idea of the present invention is to combine a first known “pressure sensor method” with a second known method, the so-called “null quantity calibration,” in such a way that the essential disadvantages of the two methods, namely the high costs due to additional pressure sensor equipment with the evaluation circuit and software in the pressure sensor method and a high application outlay in the null quantity calibration, are avoided to the greatest possible extent.

According to the present invention, a cylinder of the internal combustion engine is provided with a pressure sensor. For this “lead cylinder,” or an injector allocated to the lead cylinder, first, in a first step, the pressure sensor method is used to regulate and adapt a pre-injection of fuel. In this way, for the injector allocated to the lead cylinder a control period is known during which the injector injects a desired quantity of fuel into the lead cylinder.

Because the injected quantity of fuel is also a function of, inter alia, a rail pressure, the first step is carried out for different discrete rail pressures. The control periods determined in this way are stored in non-volatile fashion in a data storage device of a control and/or regulating device of the internal combustion engine.

In a second step, the injector of the lead cylinder is constantly controlled with the control period that was determined and adapted in the first step. Here, corresponding to the second method of null quantity calibration, quantity replacement signals, such as for example a rotational speed fluctuation of the crankshaft, are measured and, as a function of the drive train parameters, including a rotational speed of the internal combustion engine and a transmission ratio of a transmission, are entered in a training characteristic field and are stored in non-volatile fashion in a data storage device of the control and/or regulating device.

In a third step of the method according to the present invention, all further cylinders, or injectors allocated to the cylinders, are controlled in a manner corresponding to the null quantity calibration, and a quantity replacement signal resulting therefrom is determined. Here, the quantity replacement signal of the lead cylinder or of the lead injector, determined in the second step, is used as target value. If the quantity replacement signal of the cylinder to be calibrated reaches the target value, then the associated control period, or the difference from a nominal value, is stored in non-volatile fashion and is used in the internal combustion engine during firing operation for drift compensation in a manner analogous to the existing art.

In addition, it is proposed that the first step and the second step take place simultaneously. The regulation and/or adaptation of the control period according to the pressure sensor method during firing operation of the internal combustion engine presupposes that the intervals between the partial injections must be selected to be large in order to achieve an unambiguous allocation of the pressure curve or of the heating curve to the respective injection. Therefore, the spacings between the partial injections as a rule deviate from an optimum value for the internal combustion engine with regard to emissions characteristics, specific fuel consumption, and/or idling operation.

In contrast, the regulation and/or adaptation of the control period for the lead cylinder takes place very rapidly, based on the optimal conditions, so that the significantly slower adaptation of the drive train parameters can take place simultaneously. In this way, a duration of the method according to the present invention is advantageously reduced.

In a further embodiment, in the first step the control period is taken from a characteristic curve as a function of the rail pressure. So that different rail pressures can be adapted, it is necessary, at least briefly, to keep the rail pressure constant for the duration of the first step. Alternatively, a regulation or adaptation of the control period can take place in the first step even given variable rail pressure. Here, the control period is determined in an adaptive characteristic curve as a function of the rail pressure and is adapted. In this way, the operating conditions for the pressure sensor method are advantageously simplified.

In a further embodiment, in the second step a ratio of the target value quantity replacement signal to a determined actual value of the quantity replacement signal is adapted as a function of the drive train parameters. This ratio corresponds to the drive train amplification that would have to be applied during the null quantity calibration according to the existing art. In this way, the method according to the present invention reduces the application outlay.

In addition, it is proposed that in the second step, at the same time as a first test injection of a first injector into the first cylinder with a first control period, there takes place a second test injection of a second injector into a second cylinder with a second control period, and that a resulting quantity replacement signal is acquired as the superposition of a first excitation by the first cylinder and a second excitation by the second cylinder, from which the first excitation and the second excitation are reconstructed and assigned to the respective control period of the respective injector, and that for the first cylinder, using the pressure sensor method, in the first step a first injected fuel quantity is determined, and that this first injected fuel quantity is used as a reference, and that from the second excitation, using the reference, a second quantity of fuel that was injected into the second cylinder during the second control period of the second injector is calculated.

The determination according to the present invention of training values can take place during overrun operation, as in the null quantity calibration known from the existing art. However, with regard to the training process the proposed method is carried out autarkically in parallel at each of two injectors. From each test injection of the two injectors, there results an excitation of the drive train. These excitations, because they are parallel or at least approximately simultaneous, are superposed on the drive train. From this, a corresponding rotational speed signal evaluation determines an overall excitation, with magnitude and phase. From this, using the principle of vector addition, the excitation of the individual injectors can be reconstructed. Based on the quantity replacement signal reconstructed for the respective injector, there then takes place a calibration for each injector autarkically, as in a null quantity calibration known from the existing art. The advantage of the method according to the present invention here is the possibility of doubling the calibration speed without having to accept a worsening of the signal-noise ratio.

If one of the injections takes place at the lead cylinder, then the pressure sensor method is used to calculate an injected fuel quantity for this cylinder. Using this fuel quantity as reference value, from the reconstructed quantity replacement signal of the second injection the fuel quantity injected there can then be determined. Thus, the method according to the present invention provides a possibility for determining absolute injected fuel quantities without carrying out an expensive drive train adaptation corresponding to the second step described above.

The method according to the present invention works even better if the null quantity calibration is carried out in overrun operation or during a runup and/or runout of the internal combustion engine.

According to the present invention, the null quantity calibration is preferably carried out in the runout of the internal combustion engine. In order to achieve the conditions for the injector to be calibrated before the internal combustion engine is at a standstill, the regular switching off of the injection first takes place with the injector that is situated before the injector that is to be calibrated in the injection sequence, and not necessarily with the injector directly following the switching off of the ignition or of the injection. If, after switching off the ignition or the injection, the internal combustion engine rotates further beyond the working area of a cylinder, the null quantity calibration can also be carried out for more than one cylinder, or the injectors allocated thereto.

In principle, the method according to the present invention can also be carried out during a start phase or runup phase of the internal combustion engine. Here, starting from a position recognition of the stopped internal combustion engine, for example from the preceding runout phase, the next possible cylinder for which injection and ignition can take place can be determined, and the null quantity calibration can be applied for this cylinder, or the associated injector.

Subsequently, the normal start function, known from the existing art, is carried out for the next cylinder in the injection sequence. For conventional drive designs with internal combustion engines, the advantage of the method according to the present invention is a shortening of the calibration period during the overrun phase. For alternative drive designs that permit a switching off of the internal combustion engine, such as purely electric driving in parallel hybrid operation or so-called “sailing” with the internal combustion engine switched off, no overrun phases are available for a null quantity calibration as known from the existing art. Therefore, the present invention offers a possibility for carrying out a null quantity calibration without an overrun phase.

In addition, it is proposed that in the first step, for the first cylinder the first control period of the first injector is determined using null quantity calibration.

Here, in the runup phase and/or runout phase of the internal combustion engine a first control period of a first injector is determined. Using the first control period determined in this way, according to the present invention in the second step the drive train parameters are then adapted, so that the quantity replacement signals determined in the second step are used as reference values for the calibration of the further cylinders or associated injectors. In this way, the cost-intensive equipping of the lead cylinder with pressure sensors can be omitted.

It will be understood that the reference value of the first cylinder can also be used for the above-explained parallel or approximately simultaneous injection into two cylinders. Here, the reference value is not determined using the pressure sensor method, but rather is determined using null quantity calibration in the runup phase and/or runout phase of the internal combustion engine.

### BRIEF DESCRIPTION OF THE DRAWINGS

FIG. 1 shows the overall field of the present invention.

FIG. 2 shows a flow diagram of the method according to the present invention.

FIG. 3 shows a graphic representation of a superposition of two amplitude signals.

FIG. 4 shows a control period characteristic field of a second injector that, according to the present invention, was calibrated together with a first injector.

FIG. 5 shows a control period characteristic field of a first injector that, according to the present invention, was calibrated together with a second injector.

FIG. 6 shows a graphic representation of a superposition of two amplitude signals that are positioned relative to one another so that they enclose an angle τ that is not equal to a multiple of 90°.

FIG. 7 shows a graphic representation of a runout phase of an internal combustion engine.

FIG. 8 shows a graphic representation of different stop positions as a function of a position of a throttle valve.

FIG. 9 shows a graphic representation of a start phase of an internal combustion engine.

FIG. 10 shows a graphic representation of the relation between a quantity replacement signal and a pressure sensor signal.

### DETAILED DESCRIPTION OF THE INVENTION

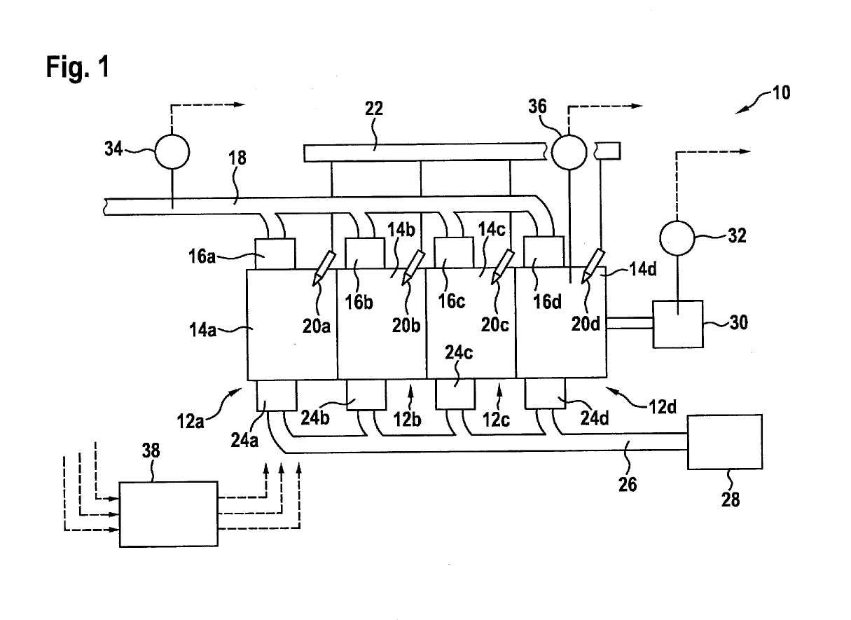

In FIG. 1, an internal combustion engine is designated as a whole by reference character 10. It is used to drive a motor vehicle (not shown), and includes four cylinders 12a through 12d, having four combustion chambers 14a through 14d. Each combustion chamber 14a through 14d has an inlet valve 16a through 16d, which are connected to an intake pipe 18. Via intake pipe 18 and inlet valves 16a through 16d, combustion air flows into the respective combustion chamber 14a through 14d. A throttle valve (not shown) is situated in intake pipe 18. Using the throttle valve, the quantity of combustion air that flows into the respective combustion chamber 14a through 14d is set as a function of an operating state of internal combustion engine 10. Fuel is injected into combustion chambers 14a through 14d via a respective injector 20a through 20d. Injectors 20a through 20d are connected to a high-pressure fuel storage device 22, also referred to as a rail.

The air-fuel mixture in combustion chambers 14a through 14d is ignited after the compression stroke, either by externally supplied ignition or self-ignition. The hot combustion gases are conducted out of combustion chambers 14a through 14d via outlet valves 24a through 24d into an exhaust gas pipe 26. This leads to an exhaust gas system 28 that cleans the exhaust gas through chemical conversion of the pollutants contained therein. Alternatively or parallel to the throttle valve in intake pipe 18, there can also be situated an exhaust gas flap exhaust gas pipe 26, with which the quantity of combustion air in combustion chambers 14a through 14d is set.

During operation of internal combustion engine 10, a crankshaft 30 is set into rotation, whose rotational speed and rotational acceleration are acquired by a high-resolution crankshaft sensor 32.

A fresh air mass flowing through intake pipe 18 to combustion chambers 14a through 14d is acquired by an air mass sensor 34. In addition, a combustion chamber pressure sensor 36 is situated at internal combustion engine 10, and acquires the pressure in combustion chamber 14d. This cylinder 12d is referred to as the lead cylinder.

The operation of internal combustion engine 10 is controlled and/or regulated by a control and/or regulating device 38. This device receives signals from, inter alia, crankshaft sensor 32, air mass sensor 34, and combustion chamber pressure sensor 36. Inter alia, injectors 20 are controlled by control and/or regulating device 38. Here it is to be noted that whenever the index a through d is not explicitly mentioned for a component, the corresponding statements always hold for all components a through d.

A fuel quantity Q injected into combustion chambers 14 by injectors 20 is, given constant pressure, proportional to a control period T of the injectors. Fuel quantity Q also influences a cylinder-individual torque M that acts on crankshaft 30.

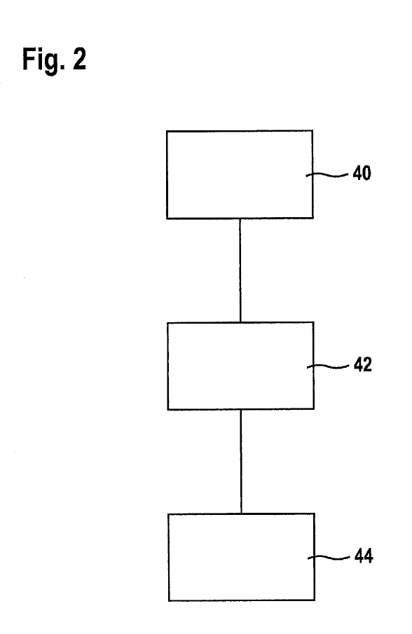

FIG. 2 shows a flow schema of an exemplary embodiment of the method according to the present invention. First, in a step 40, according to the pressure sensor method known for example from published German patent application document DE 10 2004 001 119 A1, a pre-injection is regulated and adapted for lead cylinder 12d. Here, a control period t_{vorL} is known for lead cylinder 12d that is dimensioned such that a desired quantity of fuel is injected into lead cylinder 12d via injector 20d, which is affected by drift, of lead cylinder 12d. This control period t_{vorL} is determined separately for different rail pressures, and the determined results are stored in non-volatile fashion in a data storage device of control and/or regulating device 38.

According to the present invention, first step 40 can take place both during “firing” operation, i.e. with the injection of fuel, and during an overrun phase. A precondition for the carrying out of first step 40 in firing operation is that the spacings between the partial injections are selected to be large enough that the individual partial injections can be clearly assigned to a determined heating curve in cylinder 12.

For the regulation of first control period t_{vorL} according to the pressure sensor method, according to the existing art it is required to keep the pressure in high-pressure fuel storage device 22 constant for the duration of the method. According to the present invention, the regulation can also take place in the case of variable rail pressure. For this purpose, first control period t_{vorL} is determined not at different discrete rail pressures, but rather is determined and adapted from an adaptive characteristic curve as a function of the rail pressure. Here, for the determination of the characteristic curve a regression analysis is carried out.

In a second step 42, injector 20d of lead cylinder 12d is controlled constantly with control period t_{vorL} previously determined in first step 40. Here, according to the method of null quantity calibration known for example from DE 10 2008 002 482 A1, as a function of the so-called drive train parameters, in particular the crankshaft rotational speed and the translation ratio, so-called quantity replacement signals S are determined and are entered in a characteristic field.

Quantity replacement signals S can be a quantity characterizing the rotational non-uniformity of the crankshaft, an output signal of a lambda sensor, or an output signal of an ionic current sensor. Instead of quantity replacement signal S, a ratio between a fixed target value and a measured actual value of quantity replacement signal S can also be adapted as a function of the drive parameters. This ratio corresponds to a drive train amplification that would have to be applied according to the existing art. Through the present invention, the application of the drive train amplification is omitted.

Because first step 40, the regulation of first control period t_{vorL} by the pressure sensor method, is very fast due to the optimal preconditions, second step 42, the comparatively slower adaptation of the drive train parameters, can take place simultaneously.

In a third step 44, all cylinders 12a through c, except for lead cylinder 12d, are controlled according to the known method of null quantity calibration, and quantity replacement signal S is determined. The procedure here is that quantity replacement signal S determined previously in second step 42 is used as a target value. Control period t_{vorL} of cylinders 12 is varied until the measured quantity replacement signal S reaches the target value. The associated control period T or a difference from a nominal value of control period T is stored in non-volatile fashion in a data memory device of control and/or regulating device 38.

Second step 42, the adaptation of the drive train parameters, can according to the present invention be circumvented by carrying out, at the same time as a test injection to lead cylinder 12d, a second test injection to a further cylinder 12. Here, a quantity replacement signal S is determined that results from the superposition of a first quantity replacement signal S, triggered by the test injection in lead cylinder 12d, and a second quantity replacement signal S, triggered by the second test injection in a further cylinder 12.

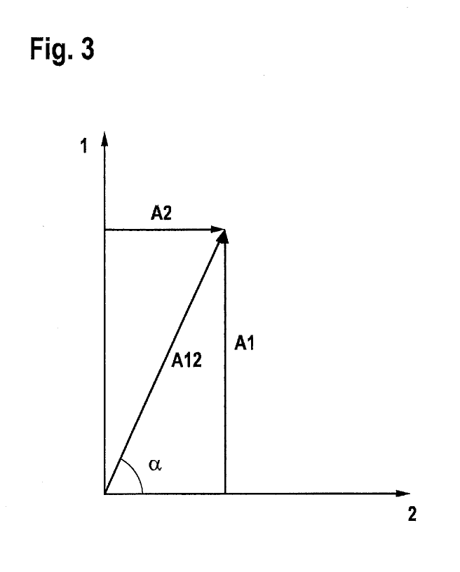

FIG. 3 shows, as part of a specific embodiment of the method according to the present invention, a reconstruction of quantity replacement signals S of two injectors 20 charged simultaneously with respective test injections, from a measured quantity replacement signal S, for example an excitation of oscillation-capable components of the drive train inside an internal combustion engine 10.

In the present case, for the example of an internal combustion engine having four cylinders it is now assumed that the two injectors 20 charged with test injections, or the correspondingly allocated cylinders 12, are situated orthogonally to one another. Accordingly, first injector 20d, or associated lead cylinder 12d, is characterized by the ordinate axis, while second injector 20, or cylinder 12, is represented by the abscissa axis. The oscillation now measured is first represented by an amplitude A12 and a corresponding phase position α. This can for example be carried out as a Fourier transformation of a corresponding rotational speed signal.

The respective phases of a pure excitation, or oscillation on lead cylinder 12d or second cylinder 12, are known from the existing art, and in the coordinate system shown here are used as axes. The measured signal having amplitude A12 and phase α is then projected onto the two axes 1 and 2 with the aid of the trigonometric functions:

A1=A12·sin(α)

A2=A12·cos(α)

where:
A12: amplitude of the overall oscillation, i.e. of the superposition of the two oscillations caused by the respective injectors
A1: the reconstructed amplitude of lead cylinder 12d
A2: the reconstructed amplitude of cylinder 12
α: the phase (position) or phase shift of measured excitation A12 relative to the phase of cylinder 12 or lead cylinder 12d.

In this way, the two individual excitations of injectors 20d and 20 that cause the overall excitation can easily be separated.

For each of the two injectors 20, first injector 20d and second injector 20, an algorithm according to the existing art is then carried out, the control period of a respective injector 20 being tracked until a specified target quantity is reached, and a training value as mentioned above according to the existing art being subsequently determined therefrom.

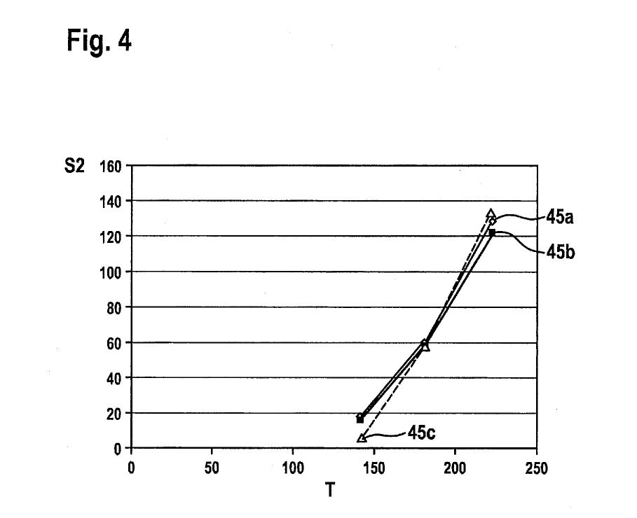

FIG. 4 shows a test result that was obtained for a motor vehicle having a four-cylinder internal combustion engine after the execution of the method according to the present invention. Here, an obtained control period characteristic field 45 of a second injector 20 was determined three times. The respective control period of a first injector 20d was here used as a parameter, and assumed the control period values 140 μs, 180 μs, and 220 μs.

Here, the three determined control period characteristic curves 45a, 45b, and 45c are entered in an illustration that shows a determined quantity replacement signal S2 of second injector 20 over control period T, measured in μs. Here, control period characteristic field 45a represents the control period characteristic field of second injector 20 for a control period of first injector 20d of 140 μs. Control period characteristic field 45b was recorded for a control period of first injector 20d of 180 μs, and control period characteristic field 45c was recorded for a control period of first injector 20d of 220 μs. Here, the three determined control period characteristic fields 45a, 45b, and 45c of second injector 20 coincide exactly, in the context of the measurement precision of the rotational speed evaluation method that was used.

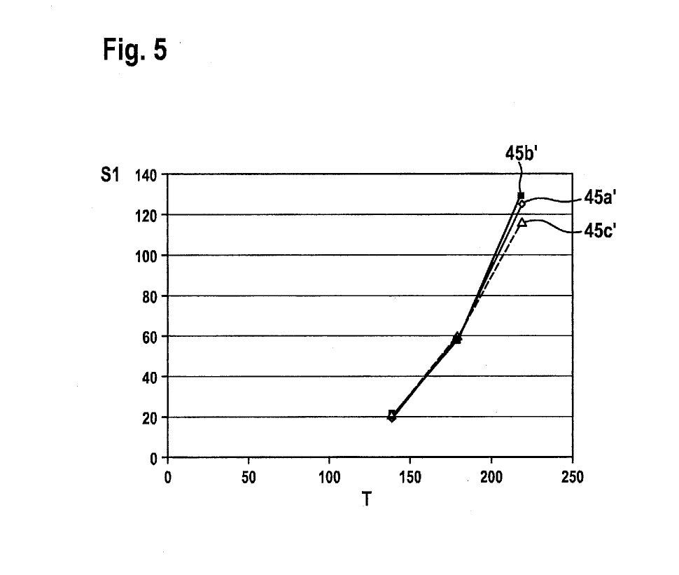

FIG. 5 shows an illustration of corresponding control period characteristic fields of first injector 20d; here, in comparison with FIG. 34, injector 20d and injector 20 have, so to speak, switched roles. In the illustration shown here, a respectively determined quantity replacement signal S1 of first injector 20d has been plotted over control period T, measured in μs. The control period of second injector 20 was here used as a parameter, and for control period characteristic field 45a′ was 140 μs, for control period characteristic field 45b′ was 180 μs, and for control period characteristic field 45c′ was 220 μs.

Here as well, the three control period characteristic fields 45′ determined for injector 20d coincide precisely, within the measurement precision of the rotational speed evaluation method, and thus demonstrate the precision of the method according to the present invention.

As an alternative to the named scenario, in which two orthogonal injectors 20d and 20, or corresponding lead cylinders 12d and cylinder 12, are charged with respective test injections, it is also possible to excite two injectors 20, or cylinders 12, that are opposite in phase. The two oscillations then die out when the injected quantities for the respective injectors 20 are equally large. This can be used for example to calibrate two injectors 20 exactly to one another if an absolute magnitude of the respective injection for which the compensation is taking place is not relevant.

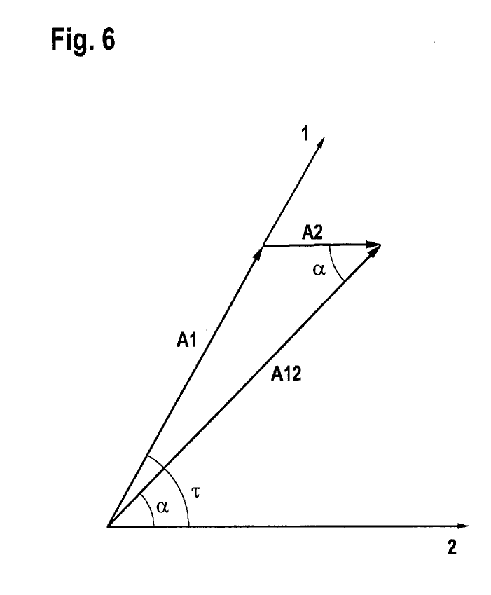

FIG. 6 shows a reconstruction carried out according to the method according to the present invention of oscillations caused respectively by a first injector 20d and by a second injector 20, from a measured overall oscillation resulting from the two oscillations. Here, injectors 20d and 20 enclose an angle τ that is not equal to a whole-number multiple of 90°.

Similar to FIG. 3, this constellation is also shown in a coordinate system, where second cylinder 12 or injector 20 is plotted on a horizontal axis and lead cylinder 12d or first injector 20d is plotted on an axis rotated by angle τ relative to the horizontal axis. The axes of this coordinate system accordingly enclose an angle τ. The measured signal is again converted into a representation with amplitude and phase, and is correspondingly plotted in this coordinate system. Here, amplitude A12 is plotted with an angle α to injector 20. A reconstruction of individual amplitudes A1 and A2 here results through application of the sine rule, analogous to the reconstruction in FIG. 3. This results in a generalized evaluation equation as follows:

A1=A12·sin(α)/sin(180°−τ)

A2=A12·sin(τ−α)/sin(180°−τ)

Because for lead cylinder 12d the quantity of fuel injected during the test injection was calculated according to the pressure sensor method, using this quantity of fuel as a reference value it is possible to calculate, from determined quantity replacement signals S, a quantity of fuel that was injected into second cylinder 12 during the second test injection. As a result, the drive train application can be omitted.

According to the existing art, it is required to carry out a null quantity calibration during an overrun phase of internal combustion engine 10. A specific embodiment of the method according to the present invention enables a shift of the null quantity calibration to a runout phase after shutting off the ignition of internal combustion engine 10. It is also conceivable to carry out the null quantity calibration in a runup phase or start phase of internal combustion engine 10, thus lengthening the runup phase by at least one cylinder segment.

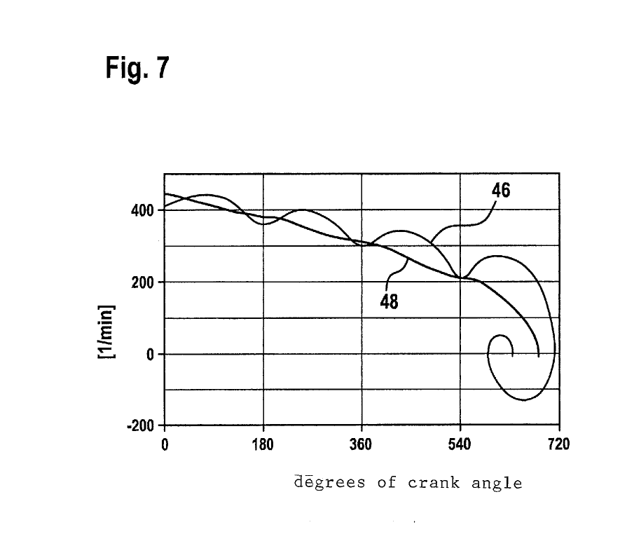

FIG. 7 shows, in a diagram, a runout of internal combustion engine 10 without injection of fuel, with open and closed throttle valve 19. On the abscissa, the crank angle is plotted in ° KW; the ordinate shows the rotational speed in rotations per minute. With open throttle valve 19 (curve 46) the gas exchange torques of individual cylinders 12 dominate relative to frictional torques and inertial torques. Compared to a closed throttle valve 19, open throttle valve 19 means that more air flows into cylinders 12, causing an increase in the maximum pressure in the cylinder. The higher maximum pressures in cylinders 12 result in a rotational non-uniformity of the crankshaft, the gas torque built up by last-compressing cylinder 12 before the zero passage of the rotational speed becoming so large that the direction of rotation reverses, and internal combustion engine 10 compressing previously compressed cylinder 12 until another change of direction of rotation occurs, and internal combustion engine 10 finally comes to a stop.

If throttle valve 19 is closed (curve 48), less air flows into cylinders 12, and as a result the maximum pressures in cylinders 12 decrease. The rotational speed curve is more uniform, and a change of direction of rotation does not take place before the internal combustion engine stops. The gas exchange torques are small relative to the inertial torques and frictional torques.

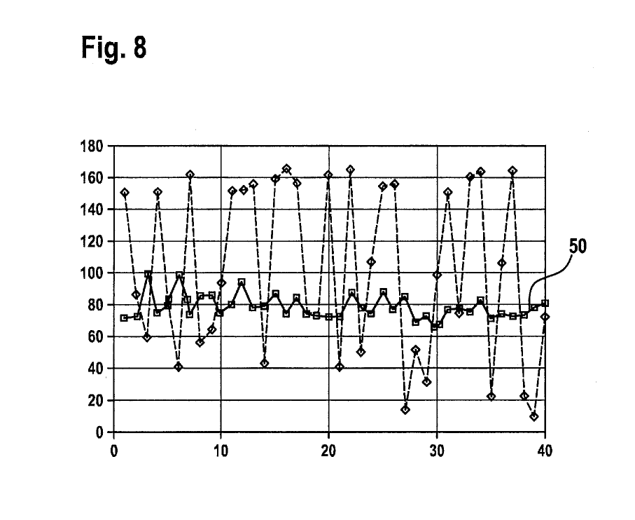

FIG. 8 shows, in a diagram, an influence of the throttle valve position on a stop position of internal combustion engine 10. On the abscissa, the consecutive numbers of the trials are plotted. The ordinate shows crank angle in degrees of crankshaft rotation before ignition top dead center.

When throttle valve 19 is closed (dashed connecting line), the stop positions of internal combustion engine 10 are scattered between lower dead center (180° crank angle before ignition top dead center) and ignition top dead center (0° crank angle before ignition top dead center). As a consequence, when throttle valve 19 is closed no setting of the stop position is possible. In contrast, when the throttle valve is open due to the increased gas exchange torques and the two changes of direction, a kind of compensation position exists at approximately 90° crank angle before ignition top dead center, in which all cylinders 12 are the same level. Line 50 shows that the deviation from the compensation position in all trials is about 10° crank angle.

The null quantity calibration begins at a control period that is certain not to cause an injection of fuel. During each runout phase, the control period is incrementally increased until an injection with combustion occurs. Recognition takes place through the comparison of the measured quantity replacement signal S, in this case the signal of crankshaft sensor 32, with a reference rotational speed signal (see FIG. 7) for which it is certain that no injection and combustion takes place. Here, difference-forming methods and/or evaluation of the rotational speed gradients can take place, and/or comparisons of rotational speed patterns can be used.

In order to achieve the conditions for a null quantity calibration for respective injector 20 in the runout phase before internal combustion engine 10 comes to a stop, it is conceivable to shut off the regular injections after shutting off the ignition not starting with the next following cylinder 12, but rather to continue the injections, and thus the combustion, and to terminate beginning with the injector that is before the injector 20 that is to be calibrated in the injection sequence, or with the associated cylinder 12.

If, after shutting off the ignition and terminating the injection, internal combustion 10 continues to rotate by more than one cylinder 12, the null quantity calibration for the following cylinder 12, or the associated injector 20, is carried out.

It is also possible to carry out the null quantity calibration in a start phase or runup phase of internal combustion engine 10. Here, starting from a position recognition of stopped internal combustion engine 10, for example from the preceding runout phase, the next possible cylinder 12 at which injection and ignition can take place is determined. The null quantity calibration is applied to this cylinder 12, or associated injector 20. Subsequently, the normal start function, known from the existing art, is applied to the next cylinder 12 in the ignition sequence.

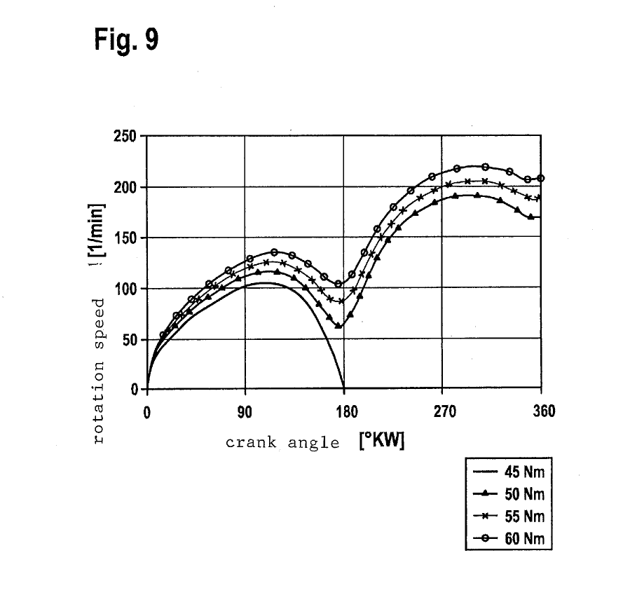

FIG. 9 shows a reference rotational speed signal associated with the start phase. The depicted rotational speed curve as a function of the crank angle is calculated as a function of a constantly applied starting torque.

Given a starting torque of 45 Nm, with full charging of first cylinder 12 a first top dead center is not reached. The kinetic energy of internal combustion engine 10 is not sufficient, in the region of the high gas exchange torque at approximately 160° crank angle, to rotate first compressing cylinder 12 through its top dead center (180° crank angle). The internal combustion engine remains at a standstill.

The reference rotational speed signal is improved by measuring and storing additional associated data, such as friction of the internal combustion engine as a function of temperature, control period of the injectors, starter rotational speed (for the null quantity calibration in the start phase), position of throttle valve 19, etc. The more precise the reference rotational speed signal, the more reliable and better becomes the null quantity calibration.

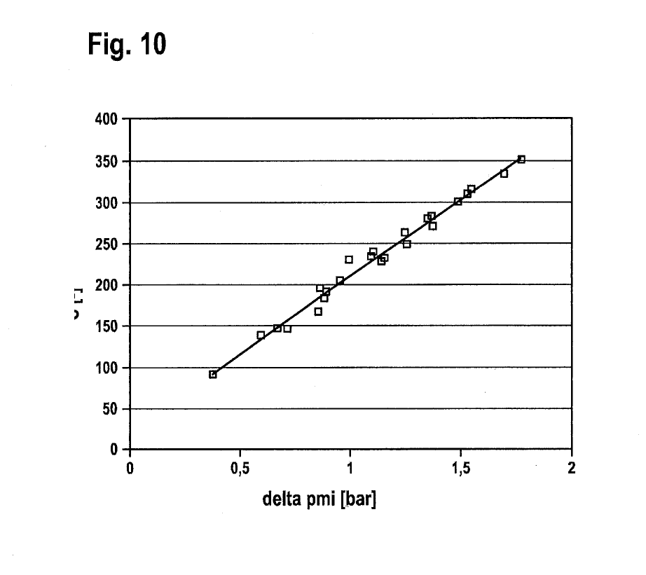

Of course, instead of the rotational speed signal of a crankshaft sensor 32, the signal of a combustion chamber pressure sensor 36 can also be used for a null quantity calibration in so-called start and/or stop operation of internal combustion engine 10. FIG. 10 shows the measured relation between quantity replacement signal S from the null quantity calibration, shown on the ordinate, and the signal from the pressure sensor method, shown on the abscissa. There is a direct/linear relation, so that the two signals can be regarded as equivalent.

1-11. (canceled)

12. A method for controlling an internal combustion engine, comprising:
in a first step, determining, using a pressure sensor method for a first injector, a first control period during which a desired quantity of fuel is injected into a lead cylinder, and storing the determined first control period;
in a second step, controlling the first injector with the first control period, and entering a quantity replacement signal resulting from the controlling of the first injector into a training characteristic field as a function of drive train parameters, wherein the training characteristic field is stored; and
in a third step, using a null quantity calibration, for all remaining cylinders of the internal combustion engine, varying a control period of the injector assigned to each respective cylinder until the quantity replacement signal determined in the second step is reached, wherein the control period corresponding to the quantity replacement signal determined in the second step is stored.

13. The method as recited in claim 12, wherein the first step and the second step take place simultaneously.

14. The method as recited in claim 12, wherein in the first step, the control period is taken from a characteristic curve as a function of the pressure in a high-pressure fuel storage device.

15. The method as recited in claim 14, wherein in the second step, a ratio of a target value of the quantity replacement signal to the determined actual value of the quantity replacement signal is adapted as a function of the drive train parameters.

16. The method as recited in claim 12, wherein:
in the second step, simultaneous with a first test injection of the first injector into the lead cylinder with the first control period, a second test injection of a second injector into a second cylinder with a second control period is performed, and the quantity replacement signal is determined as a superposition of a first excitation by the lead cylinder and a second excitation by the second cylinder, and from the determined quantity replacement signal the first excitation and the second excitation are reconstructed and are assigned to the respective control period of the respective injector; and
for the lead cylinder, in the first step, a first injected quantity of fuel is determined using the pressure sensor method, and using the first injected quantity of fuel as a reference, from the second excitation a second quantity of fuel that was injected into the second cylinder during the second control period of the second injector is calculated.

17. The method as recited in claim 12, wherein the null quantity calibration is carried out in at least one of an over-run operating phase, a run-up, and a run-out of the internal combustion engine.

18. The method as recited in claim 17, wherein a shutting off of injections after switching off the internal combustion engine does not take place until a target injector is reached in the injection sequence, wherein the target injector is the injector immediately before the injector which is to be calibrated.

19. The method according to claim 17, wherein in a run-up of the internal combustion engine, starting from a position recognition of the stopped internal combustion engine, a next cylinder in which injection and ignition can take place is determined, and an injector assigned to the determined cylinder is calibrated.

20. The method as recited in claim 12, wherein in the first step, for the lead cylinder the first control period of the first injector is determined using null quantity calibration.

21. A non-transitory, computer-readable data storage medium storing a computer program having program codes which, when executed on a computer, performs a method for controlling an internal combustion engine, the method comprising:
in a first step, determining, using a pressure sensor method for a first injector, a first control period during which a desired quantity of fuel is injected into a lead cylinder, and storing the determined first control period;
in a second step, controlling the first injector with the first control period, and entering a quantity replacement signal resulting from the controlling of the first injector into a training characteristic field as a function of drive train parameters, wherein the training characteristic field is stored; and
in a third step, using a null quantity calibration, for all remaining cylinders of the internal combustion engine, varying a control period of the injector assigned to each respective cylinder until the quantity replacement signal determined in the second step is reached, wherein the control period corresponding to the quantity replacement signal determined in the second step is stored.

22. A control device for an internal combustion engine, comprising:
a processor configured to perform the following:
in a first step, determining, using a pressure sensor method for a first injector, a first control period during which a desired quantity of fuel is injected into a lead cylinder, and storing the determined first control period;
in a second step, controlling the first injector with the first control period, and entering a quantity replacement signal resulting from the controlling of the first injector into a training characteristic field as a function of drive train parameters, wherein the training characteristic field is stored; and
in a third step, using a null quantity calibration, for all remaining cylinders of the internal combustion engine, varying a control period of the injector assigned to each respective cylinder until the quantity replacement signal determined in the second step is reached, wherein the control period corresponding to the quantity replacement signal determined in the second step is stored.
